(19) United States
(12) Patent Application Publication
(10) Pub. No.: US 2004/0218519 A1
(43) Pub. Date: Nov. 4, 2004

(54) Apparatus and method for estimation of channel state information in OFDM receivers

(76) Inventors: Rong-Liang Chiou, Taipei (TW); Yih-Ming Tsuie, Hsinchu (TW)

Correspondence Address: BIRCH STEWART KOLASCH & BIRCH, PO BOX 747, FALLS CHURCH, VA, 22040-0747, US

(21) Appl. No.: 10/426,622

(22) Filed: May 1, 2003

(51) Int. Cl. H04J 11/00

(52) U.S. Cl. 370/203; 370/252

(57) ABSTRACT

An apparatus and method for estimation of channel state information in OFDM receivers. According to the invention, a noise power estimator is provided to evaluate an average noise power estimate on a sub-carrier of an OFDM symbol. Furthermore, a channel power calculator is provided to calculate a channel power on the sub-carrier from a channel response estimate. By calculating a ratio of the channel power to the average noise power estimate of the sub-carrier, a CNR calculator can estimate a carrier-to-noise ratio on the sub-carrier. Based on the carrier-to-noise ratio of the sub-carrier and a predetermined threshold, a CSI generator thus determines a CSI estimate for the sub-carrier. If the carrier-to-noise ratio of the sub-carrier is less than the predetermined threshold, the CSI estimate for the sub-carrier is set to the carrier-to-noise ratio of the sub-carrier divided by the predetermined threshold; otherwise, it is set to one.

### BACKGROUND OF THE INVENTION

1. Field of the Invention

The invention relates to Orthogonal Frequency Division Multiplexing systems, and more particularly to an efficient scheme for estimation of channel state information in OFDM receivers.

2. Description of the Related Art

Orthogonal Frequency Division Multiplexing (OFDM) is well known as a highly spectral efficient transmission scheme capable of dealing with severe channel impairment encountered in a wireless environment. The basic idea of OFDM is to divide the available spectrum into several sub-channels (sub-carriers). By making all sub-channels narrowband, they experience almost flat fading, which makes equalization very simple. To obtain a high spectral efficiency the frequency response of the sub-channels are overlapping and orthogonal. This orthogonality can be completely maintained, even though the signal passes through a time-dispersive channel, by introducing a cyclic prefix (or guard interval). A cyclic prefix is a copy of the last part of the OFDM symbol which is pre-appended to the transmitted symbol. This makes the transmitted signal periodic, which plays a decisive roll in avoiding inter-symbol and inter-carrier interference.

OFDM can largely eliminate the effects of inter-symbol interference for high-speed transmission in highly dispersive channels by separating a single high speed bit stream into a multiplicity of much lower speed bit streams each modulating a different sub-carrier. Fortunately the apparently very complex processes of modulating (and demodulating) thousands of sub-carriers simultaneously are equivalent to Discrete Fourier Transform operations, for which efficient Fast Fourier Transform (FFT) algorithms exist. Thus integrated circuit implementations of OFDM demodulators are feasible for affordable mass-produced receivers. Furthermore, the use of error coding, interleaving and channel state information (CSI) allows OFDM to function in a manner that is well suited to the needs of the terrestrial broadcasting channel. To combat frequency-selective fading and interference, convolutional coding with soft-decision decoding can be properly integrated with an OFDM system. By means of interleaving the coded data before assigning them to OFDM sub-carriers at the modulator, clusters of errors caused by channel impairment can be broken up at the receiving end. The soft-decision decoding is carried out by a well known Viterbi decoder in an OFDM receiver. The Viterbi decoder is a sort of maximum likelihood decoder for the convolutional coding and can be fed with a soft decision comprising a measure or metric of the received signal. A metric can be made separately for each received bit to indicate a degree of confidence.

When data are modulated onto a single carrier in a time-invariant system, then a priori all data symbols suffer from the same noise power on average; the soft-decision information simply needs to take note of the random symbol-by-symbol variations that this noise causes. When data are modulated onto the multiple OFDM sub-carriers, the metrics become slightly more complicated as the various carriers will have different signal-to-noise ratios (SNR). For example, a carrier which falls into a notch in the frequency response will comprise mostly noise; one in the peak will suffer much less. Thus, in addition to the symbol-by-symbol variations, there is another factor to take account for in soft decisions: data conveyed by sub-carriers having a high SNR are a priori more reliable than those conveyed by sub-carriers having low SNR. This extra a priori information is usually known as channel state information (CSI). The CSI concept can be extended to embrace interference which affects sub-carriers selectively. The inclusion of CSI in the generation of soft decisions is the key to the unique performance of OFDM in the presence of frequency-selective fading and interference.

OFDM has therefore been chosen for two recent standards for broadcasting—Digital Audio Broadcasting (DAB) and Digital Video Broadcasting for Terrestrial (DVB-T). Systems for DAB and DVB-T have been standardized by ESTI for use in Europe and elsewhere in the world. However, the existing mass-produced consumer products are not very cost-effective. It is shown that the system performance is heavily dependent on the soft-decision decoding. In particular, how to estimate CSI is most crucial to the soft-decision decoder in OFDM systems. Accordingly, what is needed is a novel and efficient way to estimate CSI for a soft-decision decoder in an OFDM receiver.

### SUMMARY OF THE INVENTION

It is an object of the present invention to provide an apparatus for estimation of channel state information in OFDM receivers, which is well-suited to integrated circuit implementation.

It is another object of the present invention to provide a method for estimation of channel state information to improve the soft-decision decoding performance.

The present invention is generally directed to an apparatus for estimation of channel state information in OFDM receivers. According to one aspect of the invention, the apparatus includes a noise power estimator, a channel power calculator, a CNR calculator and a CSI generator. The noise power estimator evaluates an average noise power estimate on a sub-carrier of an OFDM symbol. In addition, the channel power calculator is provided to calculate a channel power on the sub-carrier from a channel response estimate. The CNR calculator can estimate a carrier-to-noise ratio on the sub-carrier by calculating a ratio of the channel power to the average noise power estimate of the sub-carrier. Thus, the CSI generator determines a CSI estimate for the sub-carrier based on the carrier-to-noise ratio of the sub-carrier and a predetermined threshold. If the carrier-to-noise ratio of the sub-carrier is less than the predetermined threshold, the CSI estimate of the sub-carrier is preferably set to the carrier-to-noise ratio of the sub-carrier divided by the predetermined threshold. Otherwise, the CSI estimate of the sub-carrier is set to one.

According to another aspect of the invention, an apparatus for estimation of channel state information in OFDM receivers is disclosed. In a preferred embodiment, a virtual carrier power calculator computes a received signal power on a virtual carrier of an OFDM symbol. A leaky integrator then applies an expectation function to the received signal power so as to evaluate an average noise power estimate on a sub-carrier of the OFDM symbol. Furthermore, a channel power calculator is employed to calculate a channel power on the sub-carrier from a channel response estimate. With a CNR calculator, a ratio of the channel power to the average noise power estimate of the sub-carrier is calculated and a carrier-to-noise ratio on the sub-carrier can be estimated accordingly. Based on the carrier-to-noise ratio of the sub-carrier and a predetermined threshold, a CSI generator determines a CSI estimate for the sub-carrier. If the carrier-to-noise ratio of the sub-carrier is greater than or equal to the predetermined threshold, the CSI estimate of the sub-carrier is set to one. Otherwise, the CSI estimate of the sub-carrier is preferably set to the carrier-to-noise ratio of the sub-carrier divided by the predetermined threshold.

According to yet another aspect of the invention, a method for estimation of channel state information in OFDM receivers is proposed. The method of invention mainly includes the following steps. An average noise power estimate is evaluated on a sub-carrier of an OFDM symbol while a channel power is calculated on the sub-carrier from a channel response estimate. A carrier-to-noise ratio can thus be estimated on the sub-carrier by calculating a ratio of the channel power to the average noise power estimate of the sub-carrier. As a result, a CSI estimate is determined for the sub-carrier based on the carrier-to-noise ratio of the sub-carrier and a predetermined threshold. If the carrier-to-noise ratio of the sub-carrier is greater than or equal to the predetermined threshold, the CSI estimate of the sub-carrier is set to one. Otherwise, the CSI estimate of the sub-carrier is preferably set to the carrier-to-noise ratio of the sub-carrier divided by the predetermined threshold.

### DESCRIPTION OF THE DRAWINGS

The present invention will be described by way of exemplary embodiments, but not limitations, illustrated in the accompanying drawings in which like references denote is similar elements, and in which:

FIG. 1 is a block diagram illustrating an OFDM receiver according to the invention;

FIG. 2 is a graph showing virtual carriers and transmitted sub-carriers of an OFDM symbol;

FIG. 3 is a flowchart illustrating a main procedure for CSI estimation according to the invention FIG. 4 is a block diagram illustrating an embodiment of a CSI estimator; and

FIG. 5 is a block diagram illustrating an embodiment of a leaky integrator.

### DETAILED DESCRIPTION OF THE INVENTION

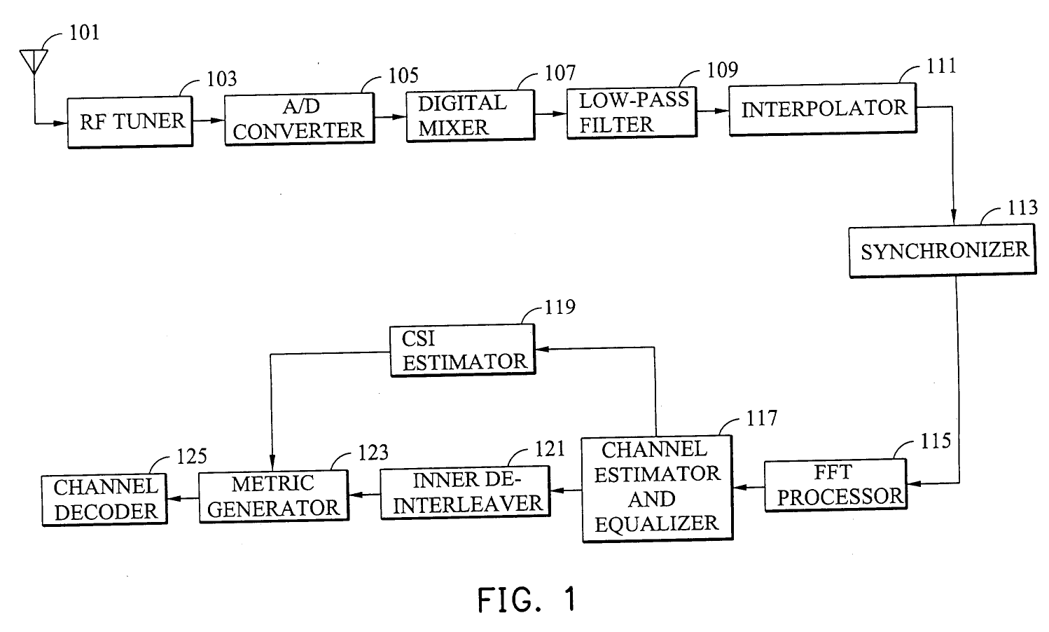

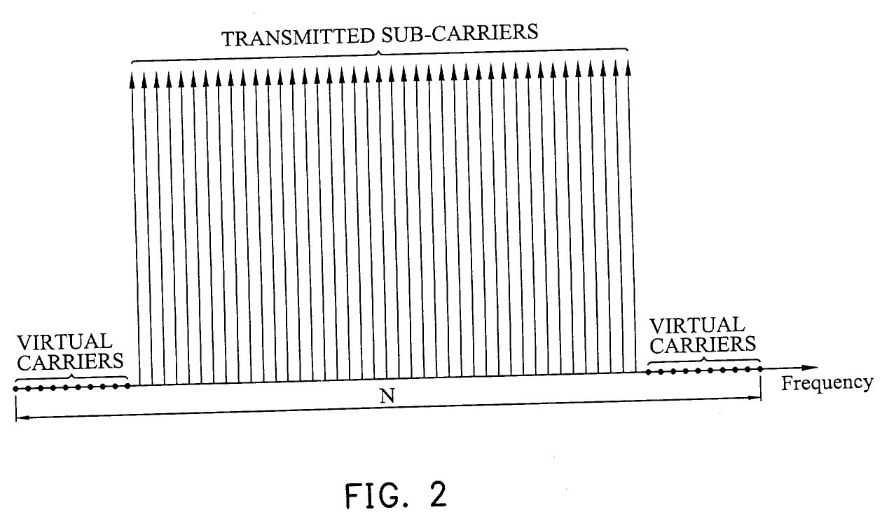

FIG. 1 shows a block diagram of an OFDM receiver in accordance with an arrangement of the invention. The receiver conforms to, but is not limited to, the ESTI standard for DVB-T. Briefly, a radio frequency (RF) signal is received via an antenna 101 and its signal band is translated to a lower frequency, namely the intermediate frequency (IF), by an RF tuner 103. The IF signal is then digitized by an A/D converter 105. A digital mixer 107 accepts the digitized IF signal at its input and converts it to baseband. The baseband signal is digitally filtered via a low-pass filter 109 and subjected to an interpolation by an interpolator 111 before entering the subsequent FFT processor 115. A synchronizer 113 is provided to find the optimum timing for the starting position of Fast Fourier Transform (FFT) window in order to minimize inter-symbol interference in the presence of multi-path distortion. The FFT processor 115 removes the guard interval from a data is symbol and applies the FFT to transform the data symbol from the time domain to the frequency domain. In DVB-T, two modes of operation are defined: a “2K mode” and an “8K mode”. Therefore the FFT processor 115 must be capable of performing a 2048-point FFT in the 2K mode or an 8192-point FFT in the 8K mode.

The FFT result is processed by a channel estimator and equalizer 117 which consists of two parts. The first part involves estimating the channel response from pilot information. The second part involves applying a correction and equalization to the data sub-carriers based on the estimated channel response. After the channel estimation, a CSI estimator 119 accepts the channel response and generates channel state information (CSI) for every sub-carrier in every symbol. In addition, the channel-equalized in-phase (I) and quadrature (Q) components of the data sub-carriers are fed to an inner de-interleaver 121 that inverts inner interleaving functions defined in the DVB-T standard before metric computation. A metric generator 123 is able to generate bit metrics using the de-interleaved data as well as per-carrier CSI. This effectively enhances the receiver performance owing to the channel state information. Finally, a channel decoder 125 receives the bit metrics from the metric generator 123 and outputs a decoded bit-stream.

The present invention mainly focuses on the CSI estimator 119. The estimation algorithm of the invention is first introduced herein and derived mathematically. According to the invention, CSI can be estimated by means of the carrier-to-noise ratio (CNR). In essence, CNR is given by:

$$C N R [ k ] = \frac{E \{ {\vert {H}^{⋒} [ k ] \vert}^{2} \}}{E \{ {\vert {W}^{⋒} [ k ] \vert}^{2} \}} \qquad ( 1 )$$

where

Ĥ[k] is the channel response estimate at the kth sub-carrier,

|Ĥ[k]|² represents the channel power of sub-carrier k,

Ŵ[k] is the white noise at the kth sub-carrier,

|Ŵ[k]|² represents the noise power of sub-carrier k, and

E{·} represents the expectation function. It is often assumed that the channel is varying sufficiently slowly so the channel is treated as static over the observation duration. Under this assumption, it is useful to mitigate effects of noise and estimation error by averaging those channel power at the kth sub-carrier for consecutive symbols, that is, E{|\hat{II}[k]|²}. However, H[k] is time-variant and varying from symbol to symbol in a mobile communication environment. Therefore, E{|Ĥ[k]|²} cannot reflect the real situation and is taken to be |Ĥ[k]|² instead. In a mobile environment, CNR at the kth sub-carrier is remodeled as follows:

$$C N R [ k ] = \frac{{\vert {H}^{⋒} [ k ] \vert}^{2}}{E \{ {\vert {W}^{⋒} [ k ] \vert}^{2} \}} \qquad ( 2 )$$

In addition to consideration of real situation, this also leads to lower computational complexity.

It should now be contemplated how to derive the average noise power, E{|Ŵ[k]|²}, in equation (2). For each sub-carrier in an OFDM symbol, the received signal can be expressed as:

Y[k]=X[k]·Ĥ[k]+Ŵ[k] (3)

where X[k] is the transmitted signal at the kth sub-carrier. Since Ĥ[k] is estimated for each sub-carrier using interpolation of pilots and X[k] is random and unknown, Ŵ[k] cannot be purely extracted without the joint effects of Ĥ[k] and X[k]. In the case of an OFDM symbol, not all of sub-carriers convey information and such sub-carriers are so-called “virtual carriers”. In DVB-T, each symbol comprises 1705 transmitted carriers out of 2048 sub-carriers in the 2K mode, for example. FIG. 2 shows an illustrative graph of transmitted sub-carriers and virtual carriers, where N=2048 in the 2K mode and N=8192 in the 8K mode. Since virtual carriers do not convey any information, the transmitted signal X[k] in equation (3) becomes zero for virtual carriers and the received signal Y[k] in a virtual carrier position reduces to Ŵ[k]. For those virtual carriers, in other words, the received signal only contains noise or interference. Therefore, the average noise power of sub-carrier k can be approximated by evaluating it from the power of the received signal in virtual carrier positions close to the transmitted sub-carriers.

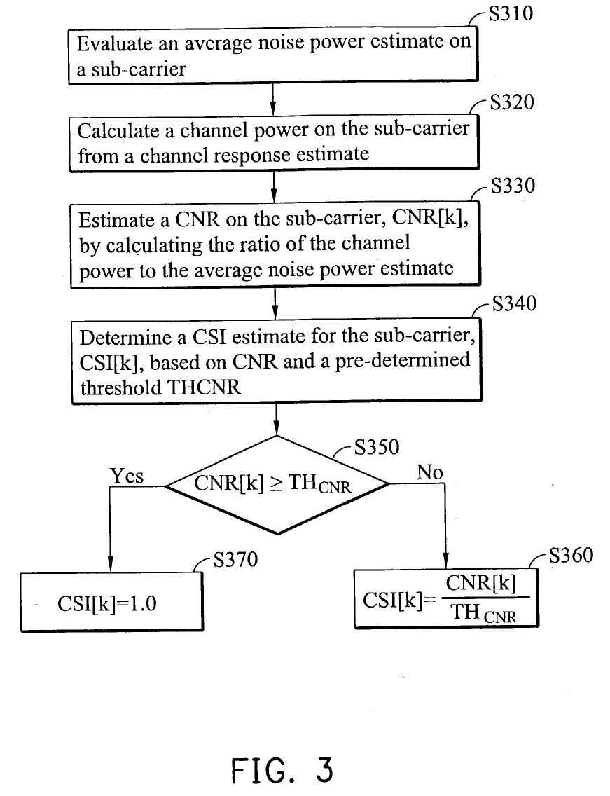

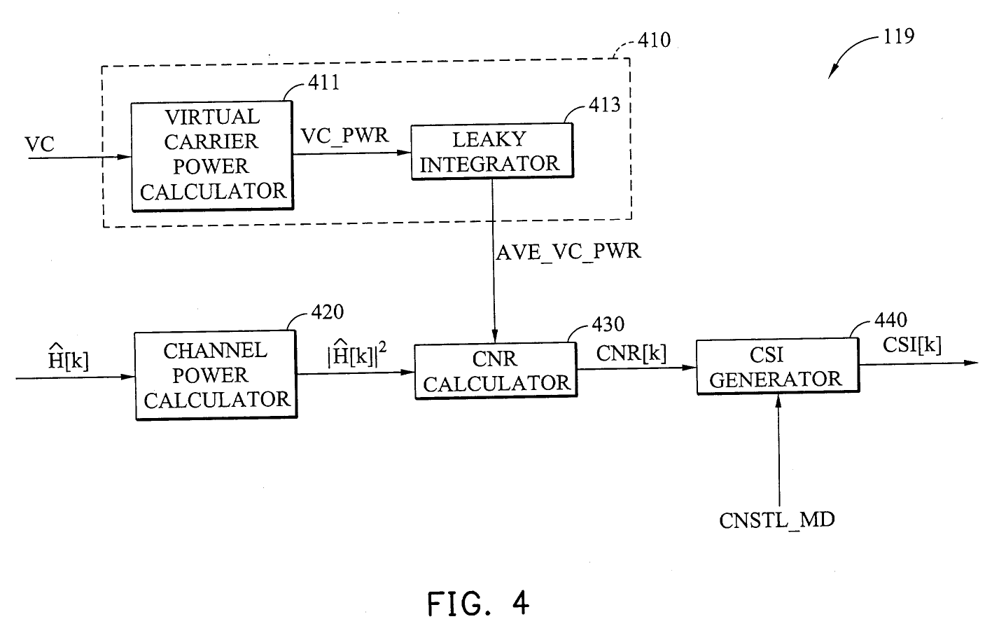

In light of the foregoing equations, a method for CSI is described herein from a flowchart of FIG. 3. In step S310, an average noise power estimate is evaluated on a sub-carrier of an OFDM symbol. According to the invention, the estimate of the average noise power at the kth sub-carrier, E{|Ŵ[k]|²}, is approximated by evaluating the expectation function of the received signal power on a virtual carrier of the OFDM symbol. In step S320, a channel power is calculated on the sub-carrier from a channel response estimate, Ĥ[k]. In step S330, the carrier-to-noise ratio can thus be estimated on the sub-carrier by calculating the ratio of |Ĥ[k]|² to E{|Ŵ[k]|²}. In step S340, an estimate of CSI is determined for the sub-carrier based on the carrier-to-noise ratio of the sub-carrier and a predetermined threshold. The predetermined threshold, TH_{CNR}, is dependent on a constellation used to modulate the OFDM symbol. Taking the DVB-T system as an example, the constellation is QPSK, 16-QAM or 64-QAM. In step S350, the carrier-to-noise ratio of sub-carrier k, CNR[k], is compared to the predetermined threshold TH_{CNR}. If CNR[k] is less than TH_{CNR}, the CSI estimate of sub-carrier k, CSI[k], is set to CNR[k] divided by TH_{CNR} in step S360. In this case, CSI[k] is given by:

$$CSI [ k ] = \frac{CNR [ k ]}{{TH}_{CNR}} for CNR [ k ] < {TH}_{CNR}$$

However, if CNR[k] is greater than or equal to TH_{CNR}, CSI[k] is set to 1.0 in step S370.

It should be noted that the 1705 transmitted sub-carriers carriers in the 2K mode or 6817 transmitted sub-carriers in the 8K mode include four different types of carriers: which are useful data carriers, continual pilots, scattered pilots and TPS pilots. In DVB-T systems, the pilots can be used for frame synchronization, frequency synchronization, time synchronization, channel estimation, transmission mode identification and can also be used to follow the phase noise. Since these pilots are transmitted with known values, they are very useful in estimation of the channel response. The channel response estimates in pilot positions can be used to evaluate their respective channel power and CSI estimates in those pilot positions are obtained accordingly. Finally, CSI estimates are generated for each useful data sub-carrier using interpolation of those CSI estimates in the pilot positions.

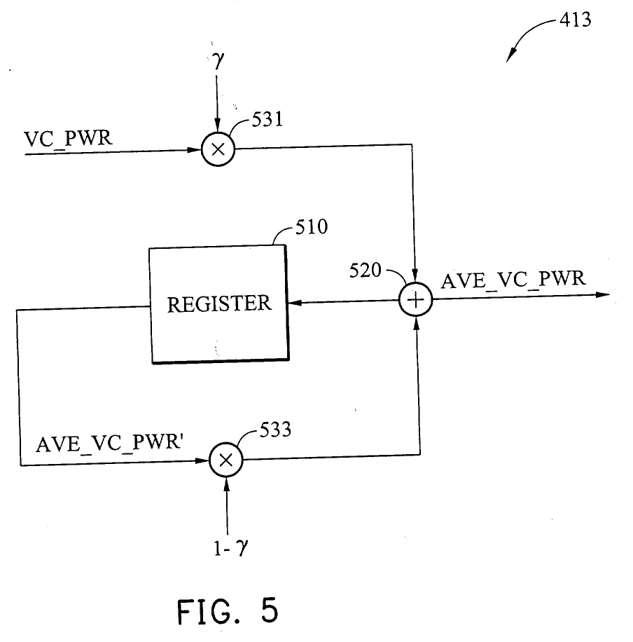

Turning now to FIG. 4, an embodiment of the CSI estimator 119 is illustrated according to the invention. The CSI estimator 119 is made up of a noise power estimator 410, a channel power calculator 420, a CNR calculator 430 and a CSI generator 440. The noise power estimator 410 is provided to evaluate an average noise power estimate on a sub-carrier of an OFDM symbol. As described above, the estimate of the average noise power is approximated by evaluating the expectation function of the received signal power on a virtual carrier close to transmitted sub-carriers of the OFDM symbol. Hence a virtual carrier power calculator 411 and a leaky integrator 413 are incorporated in the noise power estimator 410. The virtual carrier power calculator 411 accepts the received signal of the virtual carrier, VC, at its input and computes the power of the received signal on the virtual carrier. Then the leaky integrator 413 collects the received signal power, VC_PWR, from the virtual carrier power calculator 411 and generates the estimate of the average noise power, AVE_VC_PWR. FIG. 5 illustrates an embodiment of the leaky integrator 413. As depicted, the leaky integrator 413 is constituted by a register 510, an adder 520 as well as two multipliers 531 and 533. The register 510 is used to hold a historical estimate of the average noise power AVE_VC_PWR′. The currently received signal power VC_PWR and the historical estimate of the average noise power AVE_VC_PWR′ are multiplied by γ and 1-γ at multipliers 531 and 533, respectively. The multiplication results are summed at the adder 520 to yield the average noise power estimate AVE_VC_PWR. Thus,

AVE_{—}VC_{—}PWR=γ·VC_PWR+(1−γ)·AVE_{—}VC_{—}PWR′

where γ is a leaky factor. As such, the leaky integrator 413 performs the expectation function on VC_PWR to evaluate the average noise power estimate on the sub-carrier.

Referring again to FIG. 4, the channel power calculator 420 is employed to calculate a channel power on the sub-carrier from a channel response estimate, Ĥ[k]. According to the invention, the channel power calculator 420 takes the channel response estimate in a pilot position of the OFDM symbol to evaluate the channel power. The channel power of the sub-carrier, |Ĥ[k]|², is fed to the CNR calculator 430 where the ratio of |Ĥ[k]|² to AVE_VC_PWR is calculated and the carrier-to-noise ratio of the sub-carrier, CNR[k], can be estimated accordingly. The CSI generator 440 is loaded with a proper threshold TH_{CNR} according to the constellation carried by a CNSTL_MD signal. Based on CNR[k] and TH_{CNR}, the CSI generator 440 determines the CSI estimate for the sub-carrier. If CNR[k] is greater than or equal to the TH_{CNR}, the CSI estimate, CSI[k], is set to one. If CNR[k] is less than the TH_{CNR}, however, CSI[k] must be assigned a smaller weight and is preferably set to CNR[k] divided by the TH_{CNR}. In the soft-decision decoding, CSI[k] having the smaller weight indicates that data conveyed by sub-carrier k is less reliable.

In view of the above, the present invention discloses a scheme for estimation of channel state information that is simple and suitable for integrated circuit implementation. Moreover, the present invention proposes a way to estimate channel state information such that a better performance can be achieved in OFDM receivers.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for estimation of channel state information in OFDM receivers, comprising:
a noise power estimator for evaluating an average noise power estimate on a sub-carrier of an OFDM symbol;
a channel power calculator for calculating a channel power on the sub-carrier from a channel response estimate;
a CNR calculator for estimating a carrier-to-noise ratio on the sub-carrier by calculating a ratio of the channel power to the average noise power estimate of the sub-carrier; and
a CSI generator for determining a CSI estimate for the sub-carrier based on the carrier-to-noise ratio of the sub-carrier and a predetermined threshold.

2. The apparatus as recited in claim 1 wherein the average noise power estimate of the sub-carrier can be approximated by evaluating an expectation function of a received signal power on a virtual carrier of the OFDM symbol.

3. The apparatus as recited in claim 2 wherein the average noise power estimate is evaluated on the virtual carrier close to transmitted sub-carriers of the OFDM symbol.

4. The apparatus as recited in claim 2 wherein the noise power estimator comprises a leaky integrator for performing the expectation function.

5. The apparatus as recited in claim 1 wherein the channel power calculator takes the channel response estimate in a pilot position of the OFDM symbol to evaluate the channel power.

6. The apparatus as recited in claim 1 wherein the CSI estimate for the sub-carrier is set to the carrier-to-noise ratio of the sub-carrier divided by the predetermined threshold if the carrier-to-noise ratio of the sub-carrier is less than the predetermined threshold.

7. The apparatus as recited in claim 1 wherein the CSI estimate for the sub-carrier is set to one if the carrier-to-noise ratio of the sub-carrier is greater than or equal to the predetermined threshold.

8. The apparatus as recited in claim 1 wherein the predetermined threshold is dependent on a constellation used to modulate the OFDM symbol.

9. An apparatus for estimation of channel state information in OFDM receivers, comprising:
a virtual carrier power calculator for computing a received signal power on a virtual carrier of an OFDM symbol;
a leaky integrator for performing an expectation function of the received signal power to evaluate an average noise power estimate on a sub-carrier of the OFDM symbol;
a channel power calculator for calculating a channel power on the sub-carrier from a channel response estimate;
a CNR calculator for estimating a carrier-to-noise ratio on the sub-carrier by calculating a ratio of the channel power to the average noise power estimate of the sub-carrier; and
a CSI generator for determining a CSI estimate for the sub-carrier based on the carrier-to-noise ratio of the sub-carrier and a predetermined threshold.

10. The apparatus as recited in claim 9 wherein the received signal power is taken on the virtual carrier close to transmitted sub-carriers of the OFDM symbol.

11. The apparatus as recited in claim 9 wherein the channel power calculator takes the channel response estimate in a pilot position of the OFDM symbol to evaluate the channel power.

12. The apparatus as recited in claim 9 wherein the CSI estimate for the sub-carrier is set to the carrier-to-noise ratio of the sub-carrier divided by the predetermined threshold if the carrier-to-noise ratio of the sub-carrier is less than the predetermined threshold.

13. The apparatus as recited in claim 9 wherein the CSI estimate for the sub-carrier is set to one if the carrier-to-noise ratio of the sub-carrier is greater than or equal to the predetermined threshold.

14. The apparatus as recited in claim 11 wherein the predetermined threshold is dependent on a constellation used to modulate the OFDM symbol.

15. A method for estimation of channel state information in OFDM receivers, comprising the steps of:
evaluating an average noise power estimate on a sub-carrier of an OFDM symbol;
calculating a channel power on the sub-carrier from a channel response estimate;
estimating a carrier-to-noise ratio on the sub-carrier by calculating a ratio of the channel power to the average noise power estimate of the sub-carrier; and
determining a CSI estimate for the sub-carrier based on the carrier-to-noise ratio of the sub-carrier and a predetermined threshold.

16. The method as recited in claim 15 wherein the average noise power estimate of the sub-carrier can be approximated by evaluating an expectation function of a received signal power on a virtual carrier close to transmitted sub-carriers of the OFDM symbol.

17. The method as recited in claim 15 wherein the channel response estimate is taken in a pilot position of the OFDM symbol to evaluate the channel power.

18. The method as recited in claim 15 wherein the CSI estimate for the sub-carrier is set to the carrier-to-noise ratio of the sub-carrier divided by the predetermined threshold if the carrier-to-noise ratio of the sub-carrier is less than the predetermined threshold.

19. The method as recited in claim 15 wherein the CSI estimate for the sub-carrier is set to one if the carrier-to-noise ratio of the sub-carrier is greater than or equal to the predetermined threshold.

20. The method as recited in claim 15 wherein the predetermined threshold is dependent on a constellation used to modulate the OFDM symbol.
